(19) United States
(12) Patent Application Publication
(10) Pub. No.: US 2023/0175439 A1
(43) Pub. Date: Jun. 8, 2023

(54) TRANSITION PIECE, COMBUSTOR PROVIDED THEREWITH, GAS TURBINE, AND GAS TURBINE EQUIPMENT

(71) Applicant: MITSUBISHI HEAVY INDUSTRIES, LTD., Tokyo (JP)

(72) Inventors: Taiki KINOSHITA, Yokohama-shi (JP); Kentaro TOKUYAMA, Yokohama-shi (JP); Kenta TANIGUCHI, Yokohama-shi (JP); Hiroyuki SAKAKI, Yokohama-shi (JP)

(21) Appl. No.: 17/921,811

(22) PCT Filed: Jul. 15, 2021
(86) PCT No.: PCT/JP2021/026569

§ 371 Date: Oct. 27, 2022

(30) Foreign Application Priority Data
Jul. 20, 2020 (JP) 2020-123954

(51) Int. Cl. F02C 7/18

(52) U.S. Cl. CPC F02C 7/18; F05D 2220/32; F05D 2240/35; F05D 2260/20

(57) ABSTRACT

This transition piece comprises a pair of side plates which face each other across an axis, a plate inside the curve which, with reference to the axis, is arranged inside the curve where the downstream portion curves relative to the upstream portion on the axis, and a plate outside the curve which, with reference to the axis, is arranged outside the curve on the side opposite of the aforementioned inside the curve. The plate inside the curve, the plate outside the curve and the pair of side plates each has multiple passage groups which are configured from multiple cooling passages that allow flow of a cooling medium and that extend in the axis direction and are arranged side-by-side in the circumferential direction, and one or more headers which allow flow of the cooling medium and which extend in the circumferential direction. The number of the one or more headers of the plate inside the curve is less than the number of the one or more headers in the plate outside the curve and the pair of side plats.

### TECHNICAL FIELD

The present invention relates to a transition piece that defines a flow path through which combustion gas flows, a combustor provided therewith, a gas turbine, and gas turbine equipment.

Priority is claimed on Japanese Patent Application No. 2020-123954, filed Jul. 20, 2020, the content of which is incorporated herein by reference.

### BACKGROUND ART

A combustor of a gas turbine includes a transition piece that defines a flow path of combustion gas, and a main body that sprays fuel into the transition piece, together with air. The transition piece has a tubular shape around a combustor axis. In the transition piece, the fuel is combusted and combustion gas generated by the combustion of the fuel flows. For this reason, an inner peripheral surface of the transition piece is exposed to the combustion gas of extremely high temperature.

Therefore, for example, a plurality of passages through which a cooling medium flows are formed in a combustion tube (transition piece) of a combustor disclosed in PTL 1 below. The passage includes a header extending in a circumferential direction with respect to a combustor axis; a plurality of upstream-side cooling passages extending from the header to an axis upstream side; and a plurality of downstream-side cooling passages extending from the header to an axis downstream side. The header is provided to change the number of the upstream-side cooling passages with respect to the number of the downstream-side cooling passages.

### CITATION LIST

### Patent Literature

[PTL 1] Japanese Unexamined Patent Application Publication No. 2007-107541

### SUMMARY OF INVENTION

### Technical Problem

For the transition piece, while ensuring a certain level of durability is required, a reduction in manufacturing cost is desirable.

Therefore, an object of the present invention is to provide a transition piece capable of ensuring durability while suppressing manufacturing cost, a combustor provided therewith, and a gas turbine provided with the combustor.

### Solution to Problem

According to one aspect of the invention, in order to achieve the above object, there is provided a transition piece that is formed along an axis bent within an imaginary plane, in a tubular shape around the axis and that defines a periphery of a combustion gas flow path through which combustion gas flows from an upstream side to a downstream side in an axis direction in which the axis extends. The transition piece includes: a pair of side plate portions facing the imaginary plane and facing each other with the axis interposed between the pair of side plate portions; a bending inner-side plate portion that is disposed on a bending inner side on which a portion on the downstream side of the axis is bent with respect to a portion on the upstream side of the axis, with respect to the axis, and that is connected to ends on the bending inner side of the pair of side plate portions; and a bending outer-side plate portion that is disposed on a bending outer side opposite the bending inner side with respect to the axis, that faces the bending inner-side plate portion with the axis interposed between the bending outer-side plate portion and the bending inner-side plate portion, and that is connected to ends on the bending outer side of the pair of side plate portions. Each of the bending inner-side plate portion, the bending outer-side plate portion, and the pair of side plate portions includes a plurality of passage groups each including a plurality of cooling passages which extend in the axis direction, which are arranged in a circumferential direction with respect to the axis, and through which a cooling medium flows, and at least one header which extends in the circumferential direction and through which the cooling medium flows. The plurality of passage groups of each of the bending inner-side plate portion, the bending outer-side plate portion, and the pair of side plate portions are arranged in the axis direction, and the header is disposed between the plurality of passage groups of in the axis direction. The plurality of passage groups of of each of the bending inner-side plate portion, the bending outer-side plate portion, and the pair of side plate portions communicate with each other through the header disposed between the plurality of passage groups. Medium inlets into which the cooling medium flows are formed at respective ends on the downstream side of a plurality of first cooling passages that are the plurality of cooling passages forming a first passage group located furthest to the downstream side, among the plurality of passage groups of each of the bending inner-side plate portion, the bending outer-side plate portion, and the pair of side plate portions. Medium outlets from which the cooling medium flows out are formed at respective ends on the upstream side of a plurality of final cooling passages that are the plurality of cooling passages forming a final passage group located furthest to the upstream side, among the plurality of passage groups of each of the bending inner-side plate portion, the bending outer-side plate portion, and the pair of side plate portions. The number of the at least one headers of the bending inner-side plate portion is smaller than the number of the at least one headers of each of the bending outer-side plate portion and the pair of side plate portions.

In this aspect, the cooling medium flows into the first cooling passages of each of the bending inner-side plate portion, the bending outer-side plate portion, and the pair of side plate portions from the inlets thereof. Thereafter, the cooling medium inside each portion passes through the at least one header of each portion, and then flows out of the transition piece from the outlets of the final cooling passages of each portion. The cooling medium inside each portion flows from the downstream side toward the upstream side. During this process, the transition piece is cooled by the cooling medium, while the cooling medium is heated.

In this aspect, in order to maintain a cooling capacity of the cooling medium flowing from the downstream side to the upstream side by changing the number of the cooling passages on the upstream side with respect to the number of the cooling passages on the downstream side with respect to the header, the header is provided.

In this aspect, among the bending inner-side plate portion, the bending outer-side plate portion, and the pair of side plate portions, the bending inner-side plate portion is disposed furthest to the bending inner side, so that the bending inner-side plate portion has a shortest length in the axis direction. For this reason, even when the number of the at least one headers of the bending inner-side plate portion is smaller than the number of the at least one headers of each of the bending outer-side plate portion and the pair of side plate portions, a cooling capacity of the cooling medium flowing through the cooling passages of the bending inner-side plate portion can be prevented from decreasing relative to a cooling capacity of the cooling medium flowing through the cooling passages of each of the bending outer-side plate portion and the pair of side plate portions. Therefore, in this aspect, even when a passage configuration of the bending inner-side plate portion is more simplified than a passage configuration of each of the bending outer-side plate portion and the pair of side plate portions, the cooling capacity of the cooling medium flowing through the passages of the bending inner-side plate portion can be prevented from decreasing relative to the cooling capacity of the cooling medium flowing through the passages of each of the bending outer-side plate portion and the pair of side plate portions.

For this reason, in this aspect, the manufacturing cost can be suppressed while ensuring durability.

According to one aspect of the invention, in order to achieve the above object, there is provided a combustor including: the transition piece according to the foregoing aspect, and a burner that sprays fuel and compressed air into the combustion gas flow path.

According to one aspect of the invention, in order to achieve the above object, there is provided a gas turbine including: the combustor according to the foregoing aspect; a compressor that compresses air to send the compressed air to the combustor; a turbine to be driven by the combustion gas generated in the combustor; and an intermediate casing. The compressor includes a compressor rotor that is rotatable around a rotor axis, and a compressor casing covering an outer periphery of the compressor rotor. The turbine includes a turbine rotor that is rotatable around the rotor axis, and a turbine casing covering an outer periphery of the turbine rotor. The compressor rotor and the turbine rotor are connected to each other to form a gas turbine rotor. The compressor casing and the turbine casing are connected to each other through the intermediate casing. The transition piece of the combustor is disposed inside the intermediate casing such that the bending outer-side plate portion faces the gas turbine rotor and the bending inner-side plate portion faces the intermediate casing.

According to one aspect of the invention, in order to achieve the above object, there is provided gas turbine equipment including: the gas turbine according to the foregoing aspect; a cooler that cools some of the air compressed by the compressor; and a boost compressor that pressurizes the air cooled by the cooler, and that sends the pressurized air to the first cooling passages included in each of the bending inner-side plate portion, the bending outer-side plate portion, and the pair of side plate portions, as the cooling medium.

### Advantageous Effects of Invention

According to one aspect of the present invention, the manufacturing cost of the transition piece can be suppressed while ensuring durability of the transition piece.

### BRIEF DESCRIPTION OF DRAWINGS

FIG. 1 is a schematic view showing a configuration of gas turbine equipment according to one embodiment of the present invention.

FIG. 2 is a cross-sectional view of a periphery of a combustor of a gas turbine according to one embodiment of the present invention.

FIG. 3 is a perspective view of a transition piece according to one embodiment of the present invention.

FIG. 4 is a cross-sectional view taken along line IV-IV of FIG. 3.

FIG. 5 is a development view of the transition piece according to one embodiment of the present invention.

FIG. 6 is a cross-sectional view taken along line VI\/I of FIG. 5.

FIG. 7 is a cross-sectional view taken along line VII-VII of FIG. 5.

### DESCRIPTION OF EMBODIMENTS

Hereinafter, one embodiment of gas turbine equipment of the present invention will be described in detail with reference to the drawings.

### Embodiment of Gas Turbine Equipment

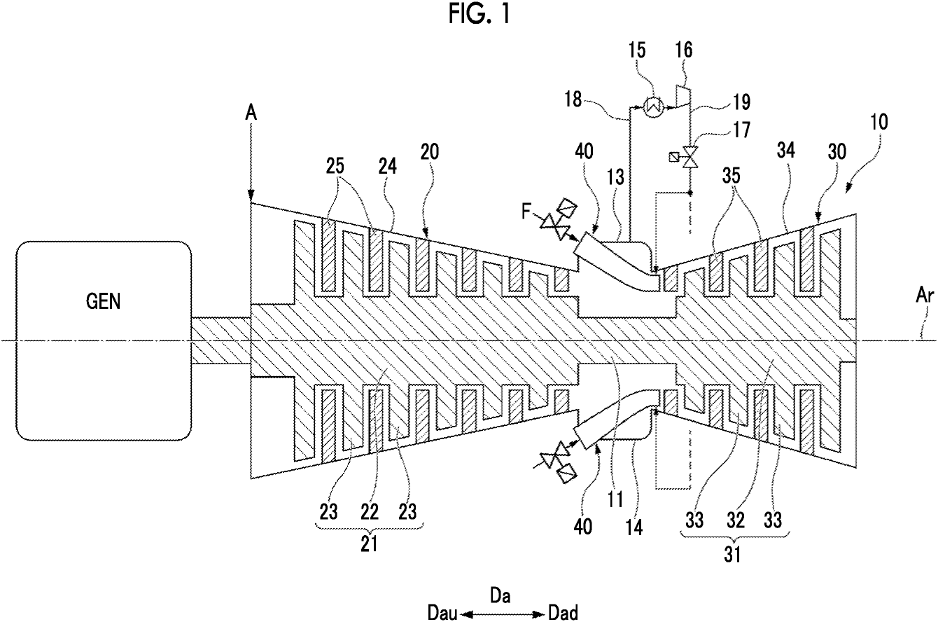

As shown in FIG. 1, gas turbine equipment of the present embodiment includes a gas turbine 10. The gas turbine 10 includes a compressor 20 that compresses outside air Ao to generate compressed air A; a plurality of combustors 40 that combust fuel F in the compressed air A to generate combustion gas G; and a turbine 30 to be driven by the combustion gas G.

The compressor 20 includes a compressor rotor 21 that rotates around a rotor axis Ar; a compressor casing 24 that covers an outer peripheral side of the compressor rotor 21; and a plurality of stator vane rows 25. Here, a direction in which the rotor axis Ar extends is referred to as a rotor axis direction Da. In addition, one side in the rotor axis direction Da is referred to as a rotor axis upstream side Dau, and the other side is referred to as a rotor axis downstream side Dad. The turbine 30 includes a turbine rotor 31 that rotates around the rotor axis Ar; a turbine casing 34 that covers an outer peripheral side of the turbine rotor 31; and a plurality of stator vane rows 35.

The compressor 20 is disposed on the rotor axis upstream side Dau with respect to the turbine 30. The compressor rotor 21 and the turbine rotor 31 are located on the same rotor axis Ar, and are connected to each other to form a gas turbine rotor 11. For example, a rotor of a generator GEN is connected to the gas turbine rotor 11. The gas turbine 10 further includes an intermediate casing 13 disposed between the compressor casing 24 and the turbine casing 34. The compressed air A from the compressor 20 flows into the intermediate casing 13. The plurality of combustors 40 are arranged in a circumferential direction with respect to the rotor axis Ar, and are attached to the intermediate casing 13. The compressor casing 24, the intermediate casing 13, and the turbine casing 34 are connected to each other to form a gas turbine casing 14.

The compressor rotor 21 includes a rotor shaft 22 extending in the rotor axis direction Da around the rotor axis Ar, and a plurality of rotor blade rows 23 attached to the rotor shaft 22. The plurality of rotor blade rows 23 are arranged in the rotor axis direction Da. Each of the rotor blade rows 23 includes a plurality of rotor blades arranged in the circumferential direction with respect to the rotor axis Ar. One stator vane row 25 of the plurality of stator vane rows 25 is disposed on the rotor axis downstream side Dad of each of the plurality of rotor blade rows 23. Each of the stator vane rows 25 is provided inside the compressor casing 24. Each of the stator vane rows 25 includes a plurality of stator vanes arranged in the circumferential direction with respect to the rotor axis Ar.

The turbine rotor 31 includes a rotor shaft 32 extending in the rotor axis direction Da around the rotor axis Ar, and a plurality of rotor blade rows 33 attached to the rotor shaft 32 . The plurality of rotor blade rows 33 are arranged in the rotor axis direction Da. Each of the rotor blade rows 33 includes a plurality of rotor blades arranged in the circumferential direction with respect to the rotor axis Ar. One stator vane row 35 of the plurality of stator vane rows 35 is disposed on the rotor axis upstream side Dau of each of the plurality of rotor blade rows 33. Each of the stator vane rows 35 is provided inside the turbine casing 34. Each of the stator vane rows 35 includes a plurality of stator vanes arranged in the circumferential direction with respect to the rotor axis Ar.

The gas turbine equipment includes a cooler 15 and a boost compressor 16 in addition to the gas turbine 10 described above. The intermediate casing 13 and a suction port of the boost compressor 16 are connected to each other by an air bleed line 18. The cooler 15 is provided in the air bleed line 18. A discharge port of the boost compressor 16 and the combustors 40 are connected each other by a cooling air line 19. The cooling line is provided with a regulation valve 17 that regulates a flow rate of cooling air. Some of the compressed air A that has been discharged from the compressor 20 of the gas turbine 10 and that has flowed into the intermediate casing 13 flows into the air bleed line 18. The compressed air A is cooled by the cooler 15, is pressurized by the boost compressor 16, and is sent to the combustors 40 as cooling air Ai.

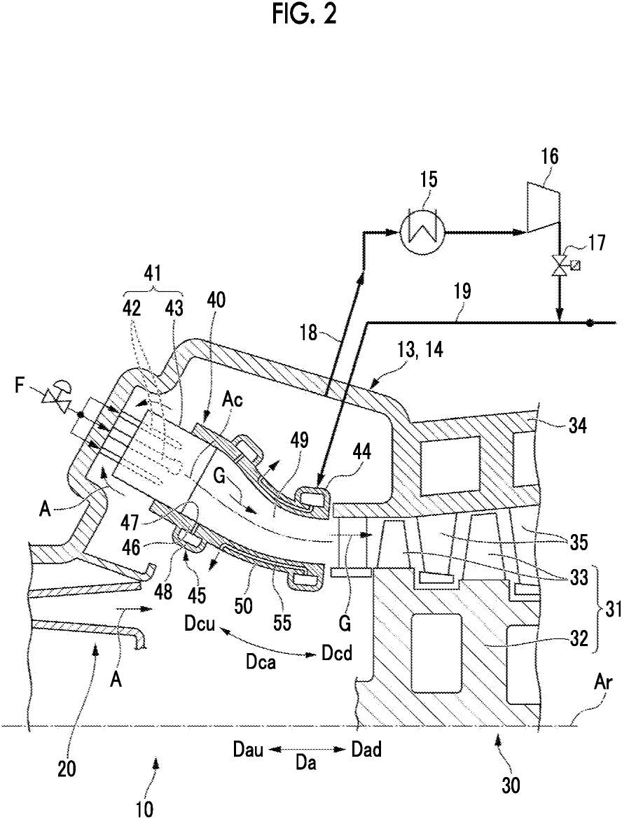

As shown in FIG. 2, each of the combustors 40 includes a transition piece 50 having a tubular shape that defines a periphery of a combustion gas flow path 49; a cooling air jacket 44; an acoustic damper 45; and a main body 41 that sprays the fuel F and the compressed air A into the transition piece 50.

The main body 41 includes a plurality of burners 42 that spray the fuel F and the compressed air A into the transition piece 50, and a frame 43 that surrounds the plurality of burners 42. The plurality of burners 42 are fixed to the frame 43. The frame 43 is fixed to the intermediate casing 13.

The transition piece 50 is formed along a combustor axis Ac in a tubular shape around the combustor axis Ac. Here, a direction in which the combustor axis Ac extends is referred to as a combustor axis direction Dca, one side of two sides facing opposite sides in the combustor axis direction Dca is referred to as a combustor axis upstream side Dcu, and the other side is referred to as a combustor axis downstream side Dcd.

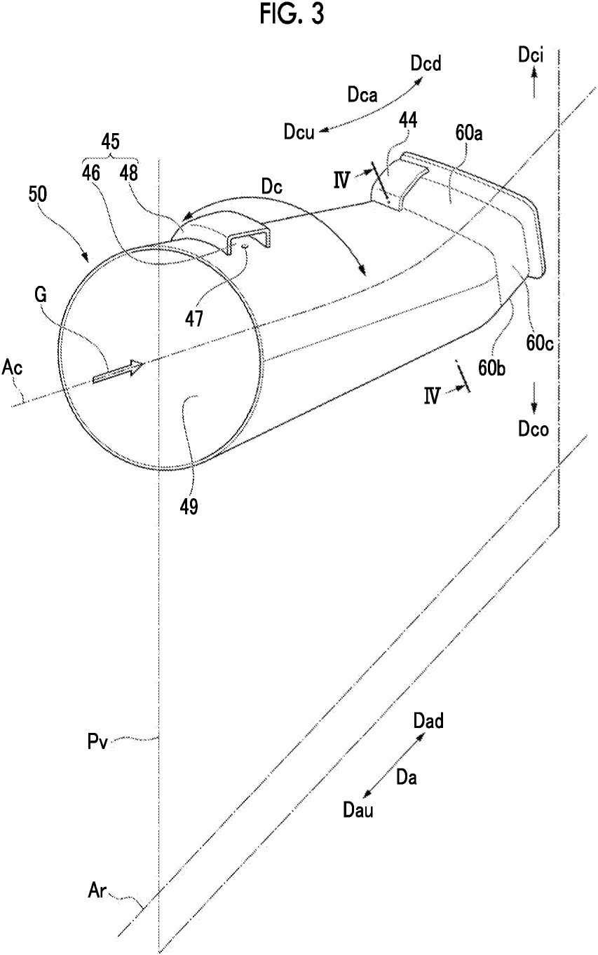

As shown in FIGS. 2 and 3, the acoustic damper 45 includes a space defining portion 46 that is a part of the transition piece 50, and an acoustic cover 48 that forms an acoustic space on an outer peripheral side of the transition piece 50 in cooperation with the space defining portion 46. The space defining portion 46 of the transition piece 50 referred to here is a portion on the combustor axis upstream side Dcu of the transition piece 50, and is a portion extending in the circumferential direction with respect to the combustor axis Ac. The acoustic cover 48 covers the space defining portion 46 of the transition piece 50 from the outer peripheral side of the transition piece 50. An acoustic hole 47 penetrating through the transition piece 50 from the outer peripheral side to an inner peripheral side is formed in the space defining portion 46 of the transition piece 50.

The cooling air jacket 44 covers a part of the transition piece 50, and forms a cooling air space on the outer peripheral side of the transition piece 50. The part of the transition piece 50 is a portion on the combustor axis downstream side Dcd of the transition piece 50, and is a portion extending in the circumferential direction with respect to the combustor axis Ac. The cooling air line 19 is connected to the cooling air jacket 44.

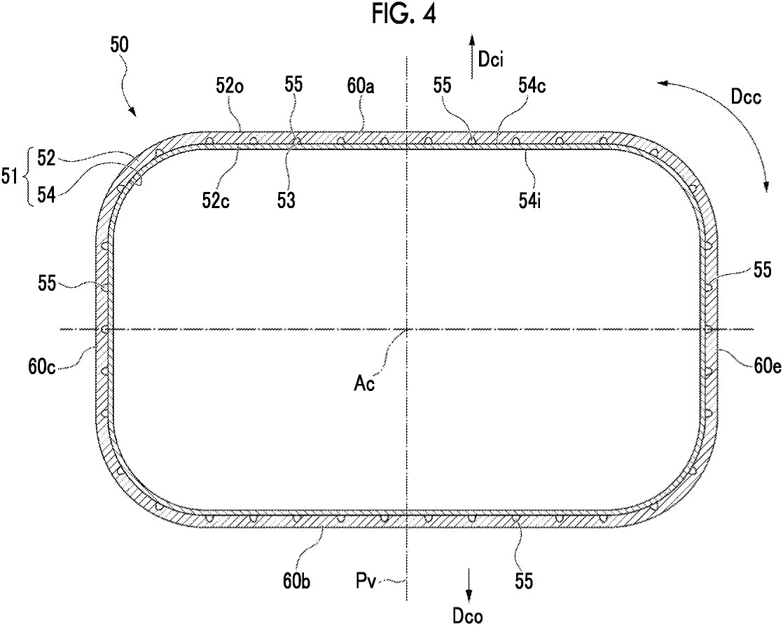

As shown in FIG. 4, the transition piece 50 is formed into a tubular shape by bending a joint plate 51. FIG. 4 is a cross-sectional view taken along line IV-IV of FIG. 3. The joint plate 51 includes an outer plate 52 and an inner plate 54. One surface of a pair of surfaces of the outer plate 52 facing opposite directions forms an outer peripheral surface 52o, and the other surface forms a joint surface 52c. The outer peripheral surface 52o of the outer plate 52 forms the outer peripheral surface 52o of the transition piece 50. In addition, one surface of a pair of surfaces of the inner plate 54 facing opposite directions forms a joint surface 54c, and the other surface forms an inner peripheral surface 54i . A plurality of long grooves 53 that are recessed to an outer peripheral surface 52o side and that are long in a certain direction are formed in the joint surface 52c of the outer plate 52. The joint surfaces 52c and 54c are joined to each other by brazing or the like, so that the outer plate 52 and the inner plate 54 form the joint plate 51. When the outer plate 52 and the inner plate 54 are joined, openings of the long grooves 53 formed in the outer plate 52 are closed by the inner plate 54, and an inside of each of the long grooves 53 becomes a passage 55 through which the cooling air Ai flows.

As shown in FIG. 3, the combustor axis Ac is located within an imaginary plane Pv including the rotor axis Ar. A portion on the combustor axis upstream side Dcu (hereinafter, simply referred to as the upstream side Dcu) of the combustor axis Ac (hereinafter, simply referred to as the axis Ac) extends in a direction in which the portion gradually approaches the rotor axis Ar on its way toward the combustor axis downstream side Dcd (hereinafter, simply referred to as the downstream side Dcd). On the other hand, a portion on the downstream side Dcd of the axis Ac extends in a direction substantially parallel to the rotor axis Ar. Therefore, the axis Ac is such that the portion on the downstream side Dcd of the axis Ac is bent within the imaginary plane Pv with respect to the portion on the upstream side Dcu of the the axis Ac. Here, a side on which the axis Ac is bent is referred to as a bending inner side Dci with respect to the axis Ac. The bending inner side Dci is a side away from the rotor axis Ar with respect to the axis Ac within the imaginary plane Pv. In addition, with this axis Ac as a reference, a side opposite the bending inner side Dci is referred to as a bending outer side Dco with respect to the axis Ac. The bending outer side Dco is a side toward the rotor axis Ar with respect to the axis Ac within the imaginary plane Pv.

As described above, since the axis Ac is bent, the transition piece 50 having a tubular shape around the axis Ac along the axis Ac is also bent.

The transition piece 50 has four regions arranged in a circumferential direction Dcc with respect to the axis Ac. As shown in FIGS. 3 and 4, one of the four regions is a bending inner-side plate portion 60a. In addition, another region of the four regions is a bending outer-side plate portion 60b. The remaining two regions of the four regions are a pair of side plate portions 60c.

The pair of side plate portions 60c face the imaginary plane Pv, and face each other with the axis Ac interposed therebetween. The bending inner-side plate portion 60a is disposed on the bending inner side Dci with respect to the axis Ac, and is connected to ends on the bending inner side Dci of the pair of side plate portions 60c. The bending outer-side plate portion 60b is disposed on the bending outer side Dco with respect to the axis Ac, faces the bending inner-side plate portion 60a with the axis Ac interposed therebetween, and is connected to ends on the bending outer side Dco of the pair of side plate portions 60c. Among the four regions, the bending inner-side plate portion 60a is disposed furthest to the bending inner side Dei, so that the bending inner-side plate portion 60a has a shortest length in the combustor axis direction Dca (hereinafter, simply referred to as the axis direction Dca).

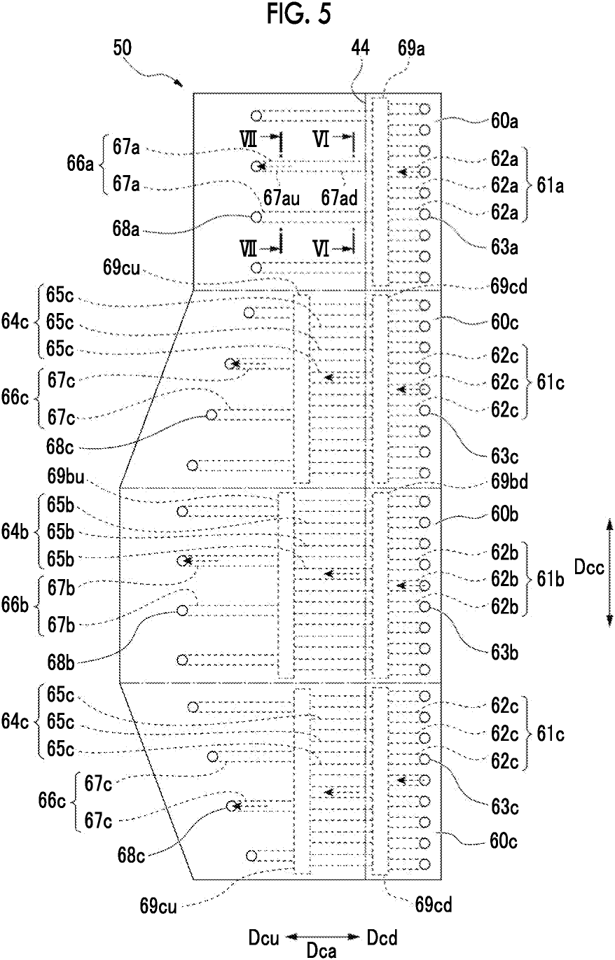

As shown in FIG. 5, bending inner-side plate portion 60a includes two passage groups 61a and 66a and one header 69a. The two passage groups 61a and 66a are arranged in the axis direction Dca. The header 69a is located between the two passage groups 61a and 66a in the axis direction Dca. Here, of the two passage groups 61a and 66a, the passage group 61a closer to the downstream side Dcd than the header 69a is referred to as a first passage group. In addition, the remaining passage group 66a is referred to as a final passage group. The two passage groups 61a and 66a include a plurality of cooling passages 62a and 67a, respectively, that extend in the axis direction Dca and that are arranged in the circumferential direction Dec. The header 69a extends in the circumferential direction Dcc. Each of the plurality of cooling passages 62a and 67a and the header 69a is the passage 55 described above through which the cooling air Ai flows.

Inlets 63a are formed at respective ends on the downstream side Dcd of the plurality of cooling passages 62a (hereinafter, referred to as first cooling passages) forming the first passage group 61a. The inlets 63a are open on the outer peripheral surface 52o of the transition piece 50. The plurality of first cooling passages 62a communicate with the cooling air space of the cooling air jacket 44 through the inlets 63a. Ends on the upstream side Dcu of the plurality of first cooling passages 62a are connected to the header 69a.

Ends on the downstream side Dcd of the plurality of cooling passages 67a (hereinafter, referred to as final cooling passages) forming the final passage group 66a are connected to the header 69a. Outlets 68a are formed at respective ends on the upstream side Dcu of the plurality of final cooling passages 67a. The outlets 68a are open on the outer peripheral surface 52o of the transition piece 50. The plurality of final cooling passages 67a communicate with a space inside the intermediate casing 13 through the outlets 68a.

The number of the plurality of final cooling passages 67a is smaller than the number of the plurality of first cooling passages 62a. Specifically, the number of the plurality of final cooling passages 67a is approximately half the number of the plurality of first cooling passages 62a.

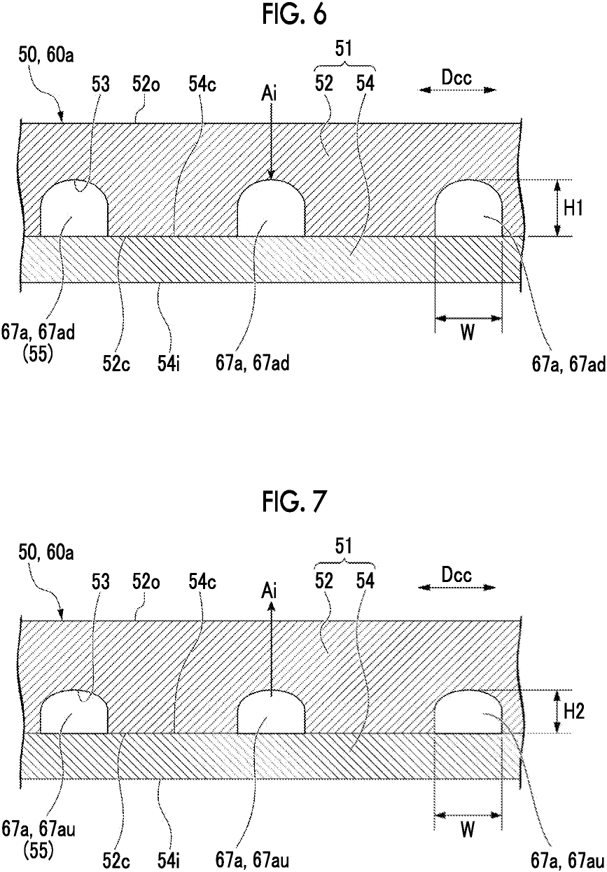

Here, as shown in FIG. 6, a passage height of a portion 67ad on the downstream side Dcd of the final cooling passage 67a is H1, and a passage width of the portion 67ad on the downstream side Dcd of the final cooling passage 67a is W. As shown in FIG. 7, a passage height H2 of a portion 67au on the upstream side Dcu of the final cooling passage 67a is slightly lower than the passage height H1 of the portion 67ad on the downstream side Dcd. In addition, the passage width W of the portion 67au on the upstream side Dcu of the final cooling passage 67a is the same as the passage width W of the portion 67ad on the downstream side Dcd. Therefore, a cross-sectional area of the portion 67au on the upstream side Dcu of the final cooling passage 67a is slightly smaller than a cross-sectional area of the portion 67ad on the downstream side Dcd of the final cooling passage 67a. In addition, the cross-sectional area of the portion 67ad on the downstream side Dcd of the final cooling passage 67a is substantially the same as a cross-sectional area of the first cooling passage 62a.

FIG. 6 is a cross-sectional view taken along line VI-VI of FIG. 5, and FIG. 7 is a cross-sectional view taken along line VII-VII of FIG. 5. In addition, the portion 67ad on the downstream side Dcd of the final cooling passage 67a is a portion including the end on the downstream side Dcd of the final cooling passage 67a. In addition, the portion 67au on the upstream side Dcu of the final cooling passage 67a is a portion including the end on the upstream side Dcu of the final cooling passage 67a and excluding the portion 67ad the downstream side Dcd of the final cooling passage 67a.

As described above, the number of the plurality of final cooling passages 67a forming the final passage group 66a closer to the upstream side Dcu than the header 69a is smaller than the number of the first cooling passages 62a forming the first passage group 61a closer to the downstream side Dcd than the header 69a. In addition, a cross-sectional area of the final cooling passage 67a is less than or equal to a cross-sectional area of the first cooling passage 62a. For this reason, when a total cross-sectional area of a plurality of cooling passages per unit circumferential length is referred to as a passage density, a passage density of the plurality of final cooling passages 67a forming the final passage group 66a is less than a passage density of the first cooling passages 62a forming the first passage group 61a.

In the bending inner-side plate portion 60a, the passage density of the final passage group 66a closer to the upstream side Dcu than the header 69a is 20% to 45% of the passage density of the first passage group 61a closer to the downstream side Dcd than the header 69a.

As shown in FIG. 5, the bending outer-side plate portion 60b includes three passage groups 61b, 64b, and 66b and two headers 69bu and 69bd. The three passage groups 61b, 64b, and 66b are arranged in the axis direction Dea. Here, among the three passage groups 61b, 64b, and 66b, the passage group 61b located furthest to the downstream side Dcd is referred to as a first passage group. Among the three passage groups 61b, 64b, and 66b, the passage group 66b located furthest to the upstream side Dcu is referred to as a final passage group. The passage group 64b located between the first passage group 61b and the final passage group 66b is referred to as a second passage group. The two headers 69bu and 69bd are arranged in the axis direction Dca. The downstream header 69bd of the two headers 69bu and 69bd is located between the first passage group 61b and the second passage group 64b in the axis direction Dea. The upstream header 69bu of the two headers 69bu and 69bd is located between the second passage group 64b and the final passage group 66b in the axis direction Dca The three passage groups 61b, 64b, and 66b include a plurality of cooling passages 62b, 65b, and 67b, respectively, that extend in the axis direction Dca and that are arranged in the circumferential direction Dcc. Each of the two headers 69bu and 69bd extends in the circumferential direction Dcc. Each of the plurality of cooling passages 62b, 65b, and 67b and a plurality of the headers 69bu and 69bd is the passage 55 described above through which the cooling air Ai flows.

Inlets 63b are formed at respective ends on the downstream side Dcd of the plurality of cooling passages 62b (hereinafter, referred to as first cooling passages) forming the first passage group 61b of the bending outer-side plate portion 60b. The inlets 63b are open on the outer peripheral surface 52o of the transition piece 50. The plurality of first cooling passages 62b communicate with the cooling air space of the cooling air jacket 44 through the inlets 63b. Ends on the upstream side Dcu of the plurality of first cooling passages 62b are connected to the downstream header 69bd.

Ends on the downstream side Dcd of the plurality of cooling passages 65b (hereinafter, referred to as second cooling passages) forming the second passage group 64b of the bending outer-side plate portion 60b are connected to the downstream header 69bd. Ends on the upstream side Dcu of the plurality of second cooling passages 65b are connected to the upstream header 69bu.

Ends on the downstream side Dcd of the plurality of cooling passages 67b (hereinafter, referred to as final cooling passages) forming the final passage group 66b of the bending outer-side plate portion 60b are connected to the upstream header 69bu. Outlets 68b are formed at respective ends on the upstream side Dcu of the plurality of final cooling passages 67b. The outlets 68b are open on the outer peripheral surface 52o of the transition piece 50. The plurality of final cooling passages 67b communicate with the space inside the intermediate casing 13 through the outlets 68b.

The number of the plurality of second cooling passages 65b is smaller than the number of the plurality of first cooling passages 62b. In addition, the number of the plurality of final cooling passages 67b is smaller than the number of the plurality of second cooling passages 65b. Specifically, the number of the plurality of final cooling passages 67b is approximately half the number of the plurality of second cooling passages 65b.

A cross-sectional area of the second cooling passage 65b is substantially the same as a cross-sectional area of the first cooling passage 62b. A cross-sectional area of the final cooling passage 67b is slightly smaller than the cross-sectional area of the second cooling passage 65b. The first cooling passage 62a of the bending inner-side plate portion 60a and the first cooling passage 62b of the bending outer-side plate portion 60b have substantially the same cross-sectional area.

For this reason, a passage density of the plurality of second cooling passages 65b forming the second passage group 64b closer to the upstream side Dcu than the downstream header 69bd in the bending outer-side plate portion 60b is less than a passage density of the plurality of first cooling passages 62b forming the first passage group 61b closer to the downstream side Dcd than the downstream header 69bd in the bending outer-side plate portion 60b. In addition, a passage density of the plurality of final cooling passages 67b forming the final passage group 66b closer to the upstream side Dcu than the upstream header 69bu in the bending outer-side plate portion 60b is less than the passage density of the plurality of second cooling passages 65b forming the second passage group 64b closer to the downstream side Dcd than the upstream header 69bu in the bending outer-side plate portion 60b.

In the bending outer-side plate portion 60b, the passage density of the final passage group 66b closer to the upstream side Dcu than the upstream header 69bu is 20% to 45% of the passage density of the second passage group 64b closer to the downstream side Dcd than the upstream header 69bu.

Similarly to the bending outer-side plate portion 60b, each of the pair of side plate portions 60c also includes three passage groups 61c, 64c, and 66c and two headers 69cu and 69cd. The three passage groups 61c, 64c, and 66c are arranged in the axis direction Dca. Here, among the three passage groups 61c, 64c, and 66c, the passage group 61c located furthest to the downstream side Dcd is referred to as a first passage group. In addition, among the three passage groups 61c, 64c, and 66c, the passage group 66c located furthest to the upstream side Dcu is referred to as a final passage group. The passage group 64c located between the first passage group 61c and the final passage group 66c is referred to as a second passage group. The two headers 69cu and 69cd are arranged in the axis direction Dca. The downstream header 69cd of the two headers 69cu and 69cd is located between the first passage group 61c and the second passage group 64c in the axis direction Dca. The upstream header 69cu of the two headers 69cu and 69cd is located between the second passage group 64c and the final passage group 66c in the axis direction Dca. The three passage groups 61c, 64c, and 66c include a plurality of cooling passages 62c, 65c, and 67c, respectively, that extend in the axis direction Dca and that are arranged in the circumferential direction Dcc. Each of the two headers 69cu and 69cd extends in the circumferential direction Dcc. Each of the plurality of cooling passages 62c, 65c, and 67c and a plurality of the headers 69cu and 69cd is the passage 55 described above through which the cooling air Ai flows.

Inlets 63c are formed at respective ends on the downstream side Dcd of the plurality of cooling passages 62c (hereinafter, referred to as first cooling passages) forming the first passage group 61c of each of the pair of side plate portions 60c. The inlets 63c are open or the outer peripheral surface 52o of the transition piece 50. The plurality of first cooling passages 62c communicate with the cooling air space of the cooling air jacket 44 through the inlets 63c.

Ends on the upstream side Dcu of the plurality of first cooling passages 62c are connected to the downstream header 69cd.

Ends on the downstream side Dcd of the plurality of cooling passages 65c (hereinafter, referred to as second cooling passages) forming the second passage group 64c of each of the pair of side plate portions 60c are connected to the downstream header 69cd. Ends on the upstream side Dcu of the plurality of second cooling passages 65c are connected to the upstream header 69cu.

Ends on the downstream side Dcd, of the plurality of cooling passages 67c (hereinafter, referred to as final cooling passages) forming the final passage group 66c of each of the pair of side plate portions 60c are connected to the upstream header 69cu. Outlets 68c are formed at respective ends on the upstream side Dcu of the plurality of final cooling passages 67c. The outlets 68c are open on the outer peripheral surface 52o of the transition piece 50. The plurality of final cooling passages 67c communicate with the space inside the intermediate casing outlets 68c.

The number of the plurality of second cooling passages 65c is smaller than the number of the plurality of first cooling passages 62c. In addition, the number of the plurality of final cooling passages 67c is smaller than the number of the plurality of second cooling passages 65c. Specifically, the number of the plurality of final cooling passages 67c is approximately half the number of the plurality of second cooling passages 65c.

A cross-sectional area of the second cooling passage 65c is substantially the same as a cross-sectional area of the first cooling passage 62c. A cross-sectional area of the final cooling passage 67c is slightly smaller than the cross-sectional area of the second cooling passage 65c. The first cooling passage 62a of the bending inner-side plate portion 60a, the first cooling passage 62b of the bending outer-side plate portion 60b, and the first cooling passage 62c of each of the pair of side plate portions 60c have substantially the same cross-sectional area.

For this reason, a passage density of the plurality of second cooling passages 65c forming the second passage group 64c closer to the upstream side Dcu than the downstream header 69cd in each of the pair of side plate portions 60c is less than a passage density of the plurality of first cooling passages 62c forming the first passage group 61c closer to the downstream side Dcd than the downstream header 69cd in each of the pair of side plate portions 60c. In addition, a passage density of the plurality of final cooling passages 67c forming the final passage group 66c closer to the upstream side Dcu than the upstream header 69cu in each of the pair of side plate portions 60c is less than the passage density of the plurality of second cooling passages 65c forming the second passage group 64c closer to the downstream side Dcd than the upstream header 69cu in each of the pair of side plate portions 60c.

In each of the pair of side plate portions 60c, the passage density of the final passage group 66c closer to the upstream side Dcu than the upstream header 69cu is 20% to 45% of the passage density of the second passage group 64c closer to the downstream side Dcd than the upstream header 69cu.

The plurality of first cooling passages 62a forming the first passage group 61a of the bending inner-side plate portion 60a, the plurality of first cooling passages 62b forming the first passage group 61b of the bending outer-side plate portion 60b, and the plurality of first cooling passages 62c forming the first passage group 61c of each of the pair of side plate portions 60c have substantially the same cross-sectional area and also have substantially the same length in the axis direction Dca.

Next, an operation of the gas turbine equipment described above will be described.

The compressor 20 compresses the outside air Ao to generate the compressed air A. The compressed air A is discharged from the compressor 20 into the intermediate casing 13. The compressed air A inside the intermediate casing 13 flows into the burners 42 of each of the combustors 40. In addition, the fuel F also flows into the burners 42 from the outside. The burners 42 spray the compressed air A into the transition piece 50, together with the fuel F. Inside the transition piece 50, the fuel F is combusted in the compressed air A to generate the combustion gas G. The combustion gas G passes through the combustion gas flow path 49 inside the transition piece 50 and is sent from the transition piece 50 to the turbine 30. The turbine 30 is driven by the combustion gas G.

Some of the compressed air A inside the intermediate casing 13 flows into the cooler 15 through the air bleed line 18, and is cooled by the cooler 15. The cooled compressed air A is pressurized by the boost compressor 16 and is sent to the transition piece 50 of each of the combustors 40 through the cooling air line 19 and through the cooling air jacket 44, as the cooling air Ai.

The inner peripheral surface 54i of the transition piece 50 is exposed to the combustion gas G of extremely high temperature. For this reason, in the present embodiment, the cooling air Ai as a cooling medium is sent to the transition piece 50 to cool the transition piece 50.

Some of the cooling air Ai inside the cooling air jacket 44 flows into the first cooling passages 62a, 62b, and 62c from the inlets 63a, 63b, and 63c of the plurality of first cooling passages 62a, 62b, and 62c forming the the bending inner-side plate first passage group 61a of portion 60a, the first passage group 61b of the bending outer-side plate portion 60b, and the first passage group 61c of each of the pair of side plate portions 60c, respectively. The cooling air Ai that has flowed into the first cooling passages 62a, 62b, and 62c flows toward the upstream side Dcu. During this process, the cooling air Ai exchanges heat with the transition piece 50. As a result, the transition piece 50 is cooled while the cooling air Ai is heated.

The cooling air Ai that has flowed through the plurality of first cooling passages 62b and 62c forming the first passage group 61b of the bending outer-side plate portion 60b and the first passage group 61c of each of the pair of side plate portions 60c, respectively, flows into the downstream header 69bd of the bending outer-side plate portion 60b and into the downstream header 69cd of each of the pair of side plate portions 60c. The cooling air Ai that has flowed into the downstream header 69bd of the bending outer-side plate portion 60b and into the downstream header 69cd of each of the pair of side plate portions 60c flows into the plurality of second cooling passages 65b and 65c forming the second passage group 64b of the bending outer-side plate portion 60b and the second passage group 64c of each of the pair of side plate portions 60c, respectively. The cooling air Ai that has flowed into the second cooling passages 65b and 65c flows toward the upstream side Dcu. During this process, the cooling air Ai exchanges heat with the transition piece 50. As a result, the transition piece 50 is cooled while the cooling air Ai is heated.

Since the passage density of the second passage groups 64b and 64c is lower than the passage density of the first passage groups 61b and 61c, a flow speed of the cooling air Ai flowing through the plurality of second cooling passages 65b and 65c forming the second passage groups 64b and 64c, respectively, is faster than a flow speed of the cooling air Ai flowing through the plurality of first cooling passages 62b and 62c forming the first passage groups 61b and 61c, respectively. For this reason, a heat transfer coefficient between the cooling air Ai flowing through the plurality of second cooling passages 65b and 65c and portions of the transition piece 50 at which the second passage groups 64b and 64c are formed is substantially the same as or higher than a heat transfer coefficient between the cooling air Ai flowing through the plurality of first cooling passages 62b and 62c and portions of the transition piece 50 at which the first passage groups 61b and 61c are formed.

The cooling air Ai that has flowed through the plurality of second cooling passages 65b and 65c forming the second passage group 64b of the bending outer-side plate portion 60b and the second passage group 64c of each of the pair of side plate portions 60c, respectively, flows to the upstream header 69bu of the bending outer-side plate portion 60b and to the upstream header 69cu of each of the pair of side plate portions 60c. The cooling air Ai that has flowed into the upstream header 69bu of the bending outer-side plate portion 60b and into the upstream header 69cu of each of the pair of side plate portions 60c flows into the plurality of final cooling passages 67b and 67c forming the final passage group 66b of the bending outer-side plate portion 60b and the final passage group 66c of each of the pair of side plate portions 60c, respectively. The cooling air Ai that has flowed into the final cooling passages 67b and 67c flows toward the upstream side Dcu. During this process, the cooling air Ai exchanges heat with the transition piece 50. As a result, the transition piece 50 is cooled while the cooling air Ai is heated.

Since the passage density of the final passage groups 66b and 66c is lower than the passage density of the second passage groups 64b and 64c, a flow speed of the cooling air Ai flowing through the plurality of final cooling passages 67b and 67c forming the final passage groups 66b and 66c, respectively, is faster than the flow speed of the cooling air Ai flowing through the plurality of second cooling passages 65b and 65c forming the second passage groups 64b and 64c, respectively. For this reason, a heat transfer coefficient between the cooling air Ai flowing through the plurality of final cooling passages 67b and 67 c and portions of the transition piece 50 at which the final passage groups 66b and 66c are formed is substantially the same as or higher than the heat transfer coefficient between the cooling air Ai flowing through the plurality of second cooling passages 65b and 65c and the portions of the transition piece 50 at which the second passage groups 64b and 64c are formed.

The cooling air Ai that has flowed through the plurality of final cooling passages 67b and 67c forming the final passage group 66b of the bending outer-side plate portion 60b and the final passage group 66c of each of the pair of side plate portions 60c, respectively, flows into the intermediate casing 13 from the outlets 68b and 68c of the final cooling passages 67b and 67c.

As described above, in the present embodiment, the bending outer-side plate portion 60b and the pair of side plate portions 60c in the transition piece 50 can be sufficiently cooled.

Some of the cooling air Ai inside the cooling air jacket 44 flows into the first cooling passages 62a from the inlets 63a of the plurality of first cooling passages 62a forming the first passage group 61a of the bending inner-side plate portion 60a. The cooling air Ai that has flowed into the first cooling passages 62a flows toward the upstream side Dcu. During this process, the cooling air Ai exchanges heat with the transition piece 50. As a result, the transition piece 50 is cooled while the cooling air Ai is heated.

The cooling air Ai that has flowed through the plurality of first cooling passages 62a forming the first passage group 61a of the bending inner-side plate portion 60a flows into the header 69a of the bending inner-side plate portion 60a. The cooling air Ai that has flowed into the header 69a flows into the plurality of final cooling passages 67a forming the final passage group 66a of the bending inner-side plate portion 60a. The cooling air Ai that has flowed into the final cooling passages 67a flows toward the upstream side Dcu. During this process, the cooling air Ai exchanges heat with the transition piece 50. As a result, the transition piece 50 is cooled while the cooling air Ai is heated.

Since the passage density of the final passage group 66a is lower than the passage density of the first passage group 61a, a flow speed of the cooling air Ai flowing through the plurality of final cooling passages 67a forming the final passage group 66a is faster than a flow speed of the cooling air Ai flowing through the plurality of first cooling passages 62a forming the first passage group 61a. For this reason, a heat transfer coefficient between the cooling air Ai flowing through the plurality of final cooling passages 67a and a portion of the transition piece 50 at which the final passage group 66a is formed is substantially the same as or higher than a heat transfer coefficient between the cooling air Ai flowing through the plurality of first cooling passages 62a and a portion of the transition piece 50 at which the first passage group 61a is formed.

Moreover, in the present embodiment, the cross-sectional area of the portion 67au on the upstream side Dcu of the final cooling passage 67a of the bending inner-side plate portion 60a is smaller than the cross-sectional area of the portion 67ad on the downstream side Dcd of the final cooling passage 67a. For this reason, a flow speed of the cooling air Ai flowing through the portion 67au on the upstream side Dcu of the final cooling passage 67a is faster than a flow speed of the cooling air Ai flowing through the portion 67ad on the downstream side Dcd of the final cooling passage 67a. Therefore, a heat transfer coefficient between the cooling air Ai flowing through the portion 67au on the upstream side Dcu of the final cooling passage 67a and a periphery of the portion 67au on the upstream side Dcu of the final cooling passage 67a in the transition piece 50 is substantially the same as or higher than a heat transfer coefficient between the cooling air Ai flowing through the portion 67ad on the downstream side Dcd of the final cooling passage 67a and a periphery of the portion 67ad on the downstream side Dcd of the final cooling passage 67a in the transition piece 50.

In the present embodiment, in order to maintain a cooling capacity of the cooling medium flowing from the downstream side Dcd to the upstream side Dcu by changing the number of the cooling passages 67a, the number of the cooling passages 65b and 67b, and the number of the cooling passages 65c and 67c on the upstream side Dcu with respect to the number of the cooling passages 62a, to the number of the cooling passages 62b and 65b, and to the number of the cooling passages 62c and 65c on the downstream side Dcd with respect to the header 69a, to the headers 69bu and 69bd, and to the headers 69cu and 69cd, respectively, the headers 69a, 69bu, 69bd, 69cu, and 69cd are provided.

In the present embodiment, the number of the headers 69a of the bending inner-side plate portion 60a is 1, and the number of the headers 69bu and 69bd of the bending outer-side plate portion 60b and the number of the headers 69cu and 69cd of each of the pair of side plate portions 60c is 2. Namely, the number of the headers 69a of the bending inner-side plate portion 60a is smaller than the number of the headers 69bu and 69bd of the bending outer-side plate portion 60b and is smaller than the number of the headers 69cu 69cd of each of the pair of side plate portions 60c. As described above, in the transition piece 50, among the four regions arranged in the circumferential direction Dcc, the bending inner-side plate portion 60a is disposed furthest to the bending inner side Dci, so that the bending inner-side plate portion 60a has the shortest length in the axis direction Dca. For this reason, a total passage length that is the sum of a length of the first cooling passage 62a and a length of the final cooling passage 67a in the bending inner-side plate portion 60a is shorter than a total flow path length that is the sum of a length of the first cooling passage 62b, a length of the second cooling passage 65b, and a length of the final cooling passage 67b in the bending outer-side plate portion 60b, and is shorter than a total flow path length that is the sum of a length of the first cooling passage 62c, a length of the second cooling passage 65c, and a length of the final cooling passage 67c in each of the pair of side plate portions 60c. Therefore, even when the number of the headers 69a of the bending inner-side plate portion 60a is smaller than the number of the headers 69bu and 69bd of the bending outer-side plate portion 60b and is smaller than the number of the headers 69cu and 69cd of each of the pair of side plate portions 60c, a cooling capacity of the cooling air Ai flowing through the cooling passages 62a and 67a of the bending inner-side plate portion 60a can be prevented from decreasing relative to a cooling capacity of the cooling air Ai flowing through the cooling passages 62b, 65b and 67b of the bending outer-side plate portion 60b and through the cooling passages 62c, 65c, and 67c of each of the pair of side plate portions 60c.

As a result, in the present embodiment, even when a passage configuration of the bending inner-side plate portion 60a is more simplified than a passage configuration of each of the bending outer-side plate portion 60b and the pair of side plate portions 60c, the bending inner-side plate portion 60a of the transition piece 50 can be sufficiently cooled.

Therefore, in the present embodiment, the manufacturing cost of the transition piece 50 can be suppressed while ensuring durability of the transition piece 50.

### Modification Examples

In the above embodiment, the outlets 68a, 68b, and 68c of the final cooling passages 67a, 67b, and 67c are formed on the outer peripheral surface 52o of the transition piece 50 at portions closer to the downstream side Dcd than the space defining portion 46 of the acoustic damper 45. For this reason, in the above embodiment, the cooling air Ai that has passed through the final cooling passages 67a, 67b, and 67c of the transition piece 50 flows into the intermediate casing 13 from the outlets 68a, 68b, and 68c of the final cooling passages 67a, 67b, and 67c. However, the outlets 68a, 68b, and 68cof the final cooling passages 67a, 67b, and 67c may be formed on the outer peripheral surface 52o of the transition piece 50 at the space defining portion 46 of the acoustic damper 45. In this case, the cooling air Ai that has passed through the final cooling passages 67a, 67b, and 67c of the transition piece 50 flows into the acoustic space from the outlets 68a, 68b, and 68c of the final cooling passages 67a, 67b, and 67c, and then flows into the combustion gas flow path 49 of the transition piece 50 from the acoustic hole 47 of the acoustic damper 45.

In the above embodiment, the number of the headers 69a of the bending inner-side plate portion 60a is 1, and each of the number of the headers 69bu and 69bd of the bending outer-side plate portion 60b and the number of the headers 69cu and 69cd of each of the pair of side plate portions 60c is 2. However, as long as the number of the headers of the bending portion 60b and of the pairof the bending outer-side plate portion 60b and of the pair of side plate portions 60c is larger than the number of the headers of the bending inner-side plate portion 60a, the number of the headers of the bending inner-side plate portion 60a may be 2 or more.

### Additional Notes

For example, the transition piece in the above embodiment is understood as follows.

(1) According to a first aspect, there is provided a transition piece 50 that is formed along an axis Ac bent within an imaginary plane Pv, in a tubular shape around the axis Ac, and that defines a periphery of a combustion gas flow path 49 through which combustion gas G flows from an upstream side Dcu to a downstream side Dcd in an axis direction Dca in which the axis Ac extends, the transition piece 50 including: a pair of side plate portions 60c facing the imaginary plane Pv and facing each other with the axis Ac interposed between the pair of side plate portions 60c; a bending inner-side plate portion 60a that is disposed on a bending inner side Dci on which a portion on the downstream side Dcd of the axis Ac is bent with respect to a portion on the upstream side Dcu of the axis Ac, with respect to the axis Ac, and that is connected to ends on the bending inner side Dci of the pair of side plate portions 60c; and a bending outer-side plate portion 60b that is disposed on a bending outer side Dco opposite the bending inner side Dci with respect to the axis Ac, that faces the bending inner-side plate portion 60a with the axis Ac interposed between the bending outer-side plate portion 60b and the bending inner-side plate portion 60a, and that is connected to ends on the bending outer side Dco of the pair of side plate portions 60c. Each of the bending inner-side plate portion 60a, the bending outer-side plate portion 60b, and the pair of side plate portions 60c includes a plurality of passage groups 61a and 66a, a plurality of passage groups 61b, 64b, and 66b, and a plurality of passage groups 61c, 64c, and 66c, respectively, that include a plurality of cooling passages 62a and 67a, a plurality of cooling passages 62b, 65b and 67b, and a plurality of cooling passages 62c, 65c and 67c, respectively, which extend in the axis direction Dca, which are arranged in a circumferential direction Dcc with respect to the axis Ac, and through which a cooling medium flows, and at least one header 69a, at least one headers 69bu and 69bd, and at least one headers 69cu and 69cd, respectively, which extend in the circumferential direction Dcc and through which the cooling medium flows. The plurality of passage groups 61a and 66a of the bending inner-side plate portion 60a, the plurality of passage groups 61b, 64b, and 66b of the bending outer-side plate portion 60b, and the plurality of passage groups 61c, 64c, and 66c of each of the pair of side plate portions 60c are arranged in the axis direction Dca, and the header 69a, the headers 69bu and 69bd, and the headers 69cu and 69cd are disposed between the plurality of passage groups 61a and 66a, between the plurality of passage groups 61b, 64b, and 66b, and between the plurality of passage groups 61c, 64c, and 66c, respectively. The plurality of passage groups 61a and 66a of the bending inner-side plate portion 60a communicate with each other through the header 69a disposed between the plurality of passage groups 61a and 66a, the plurality of passage groups 61b, 64b, and 66b of the bending outer-side plate portion 60b communicate with each other through the headers 69bu and 69bd disposed between the plurality of passage groups 61b, 64b, and 66b, and the plurality of passage groups 61c, 64c, and 66c of each of the pair of side plate portions 60c communicate with each other through the headers 69cu and 69cd disposed between the plurality of passage groups 61c, 64c, and 66c. Medium inlets 63a into which the cooling medium flows are formed at respective ends on the downstream side Dcd of a plurality of first cooling passages 62a that are the plurality of cooling passages forming a first passage group 61a located furthest to the downstream side Dcd, among the plurality of passage groups 61a and 66a of the bending inner-side plate portion 60a, medium inlets 63b into which the cooling medium flows are formed at respective ends on the downstream side Dcd of a plurality of first cooling passages 62b that are the plurality of cooling passages forming a first passage group 61b located furthest to the downstream side Dcd, among the plurality of passage groups 61b, 64b, and 66b of the bending outer-side plate portion 60b, and medium inlets 63c into which the cooling medium flows are formed at respective ends on the downstream side Dcd of a plurality of first cooling passages 62c that are the plurality of cooling passages forming a first passage group 61c located furthest to the downstream side Dcd, among the plurality of passage groups 61c, 64c, and 66c of each of the pair of side plate portions 60c. Medium outlets 68a from which the cooling medium flows out are formed at respective ends on the upstream side Dcu of a plurality of final cooling passages 67a that are the plurality of cooling passages forming a final passage group 66a located furthest to the upstream side Dcu, among the plurality of passage groups 61a and 66a of the bending inner-side plate portion 60a, medium outlets 68b from which the cooling medium flows out are formed at respective ends on the upstream side Dcu of a plurality of final cooling passages 67b that are the plurality of cooling passages forming a final passage group 66b located furthest to the upstream side Dcu, among the plurality of passage groups 61b, 64b, and 66b of the bending outer-side plate portion 60b, and medium outlets 68c from which the cooling medium flows out are formed at respective ends on the upstream side Dcu of a plurality of final cooling passages 67c that are the plurality of cooling passages forming a final passage group 66c located furthest to the upstream side Dcu, among the plurality of passage groups 61c, 64c, and 66c of each of the pair of side plate portions 60c. The number of the at least one headers 69a of the bending inner-side plate portion 60a is smaller than the number of the at least one headers 69bu and 69bd of the bending outer-side plate portion 60b and is smaller than the number of the at least one headers 69cu and 69cd of each of the pair of side plate portions 60c.

In this aspect, the cooling medium flows into the first cooling passages 62a, 62b, and 62c of the bending inner-side plate portion 60a, the bending outer-side plate portion 60b, and each of the pair of side plate portions 60c from the inlets 63a, 63b, and 63c thereof, respectively. Thereafter, the cooling medium inside each portion passes through the at least one header 69a, through the at least one headers 69bu and 69bd, and through the at least one headers 69cd and 69cd of the portions, and then flows out of the transition piece 50 from the outlets 68a of the final cooling passages 67a, from the outlets 68b of the final cooling passages 67b, and from the outlets 68c of the final cooling passages 67c of the portions, respectively. The cooling medium inside each portion flows from the downstream side Dcd toward the upstream side Dcu. During this process, the transition piece 50 is cooled by the cooling medium, while the cooling medium is heated.

In this aspect, in order to maintain a cooling capacity of the cooling medium flowing from the downstream side Dcd to the upstream side Dcu by changing the number of the cooling passages 67a, the number of the cooling passages 65b and 61b, and the number of the cooling passages 65c and 67c on the upstream side Dcu with respect to the number of the cooling passages 62a, to the number of the cooling passages 62b and 65b, and to the number of the cooling passages 62c and 65c on the downstream side Dcd with respect to the header 69a, to the headers 69bu and 69bd, and to the headers 69cu and 69cd, respectively, the headers 69a, 69bu, 69bd, 69cu, and 69cd are provided.

In this aspect, among the bending inner-side plate portion 60a, the bending outer-side plate portion 60b, and the pair of side plate portions 60c, the bending inner-side plate portion 60a is disposed furthest to the bending inner side Dci, so that the bending inner-side plate portion 60a has a shortest length in the axis direction Dca . For this reason, even when the number of the at least one header 69a of the bending inner-side plate portion 60a is smaller than the number of the at least one headers 69bu and 69bd of the bending outer-side plate portion 60b and is smaller than the number of the at least one headers 69cu and 69cd of each of the pair of side plate portions 60c, a cooling capacity of the cooling medium flowing through the cooling passages 62a and 67a of the bending inner-side plate portion 60a can be prevented from decreasing relative to a cooling capacity of the cooling medium flowing through the cooling passages 62b, 65b, and 67b of the bending outer-side plate portion 60b and through the cooling passages 62c, 65c, and 67c of each of the pair of side plate portions 60c. Therefore, in this aspect, even when a passage configuration of the bending inner-side plate portion 60a is more simplified than a passage configuration of each of the bending outer-side plate portion 60b and the pair of side plate portions 60c, the cooling capacity of the cooling medium flowing through the passages of the bending inner-side plate portion 60a can be prevented from decreasing relative to the cooling capacity of the cooling medium flowing through the passages of each of the bending outer-side plate portion 60b and the pair of side plate portions 60c.

For this reason, in this aspect, the manufacturing cost can be suppressed while ensuring durability.

(2) According to the transition piece 50 of a second aspect, in each of the transition piece 50 of the first aspect, in the bending inner-side plate portion 60a, the bending outer-side plate portion 60b, and the pair of side plate portions 60c, a passage density that is a total cross-sectional area of the plurality of cooling passages 67a, of the plurality of cooling passages 65b and 67b, and of the plurality of cooling passages 65c and 67c per unit circumferential length in the plurality of cooling passages 67a, the plurality of cooling passages 65b and 67b, and the plurality of cooling passages 65c and 67c communicating with the header 69a, with the headers 69bu and 69bd, and with the headers 69cu and 69cd and forming the passage group 66a, the passage groups 64b and 66b, and the passage groups 64c and 66c on the upstream side Dcu with respect to the header 69a, to the headers 69bu and 69bd, and to the headers 69cu and 69cd, respectively, is less than a passage density of each of the plurality of cooling passages 62a, the plurality of cooling passages 62b and 65b, and the plurality of cooling passages 62c and 65c communicating with the header 69a, with the headers 69bu and 69bd, and with the headers 69cu and 69cd and forming the passage group 61a, the passage groups 61b and 64b, and the passage groups 61c and 64c on the downstream side Dcd with respect to the header 69a, to the headers 69bu and 69bd, and to the headers 69cu and 69cd, respectively.

In this aspect, the passage density of the passage groups 66a, 64b, 66b, 64c, and 66c on the upstream side Dcu is lower than the passage density of the passage groups 61a, 61b, 64b, 61c, and 64c on the downstream side Dcd. For this reason, a flow speed of the cooling air Ai flowing through the plurality of cooling passages 67a, 65b, 67b, 65c, and 67c forming the passage groups 66a, 64b, 66b, 64c, and 66c on the upstream side Dcu, respectively, is faster than a flow speed of the cooling air Ai flowing through the plurality of cooling passages 62a, 62b, 65b, 62c, and 65c forming the passage groups 61a, 61b, 64b, 61c, and 64c on the downstream side Dcd, respectively. Therefore, heat transfer coefficients between the cooling air Ai flowing through the plurality of cooling passages 67a, 65b, 67b, 65c, and 67c forming the passage groups 66a, 64b, 66b, 64c, and 66c on the upstream side Dcu, respectively, and portions of the transition piece 50 at which the passage groups 66a, 64b, 66b, 64c, and 66c on the upstream side Dcu are formed are substantially the same as or higher than heat transfer coefficients between the cooling air Ai flowing through the plurality of cooling passages 62a, 62b, 65b, 62c, and 65c forming the passage groups 61a, 61b, 64b, 61c, and 64c on the downstream side Dcd and portions of the transition piece 50 at which the passage groups 61a, 61b, 64b, 61c, and 64c on the downstream side Dcd are formed.

(3) According to the transition piece 50 of a third aspect, in each of the transition piece 50 of the second aspect, in the bending inner-side plate portion 60a, the bending outer-side plate portion 60b, and the pair of side plate portions 60c, the passage density of the final passage groups 66a, 66b, and 66c is 25% to 45% of the passage density of the passage groups 62a, 64b, and 64c located on the downstream side Dcd of the headers 69a, 69bu, and 69cu with which the final passage groups 66a, 66b, and 66c communicate.

(4) According to the transition piece 50 of a fourth aspect, in each of the transition piece 50 of any one of the first to third aspects, in the bending inner-side plate portion 60a, the bending outer-side plate portion 60b, and the pair of side plate portions 60c, the number of the plurality of cooling passages 67a, 65b, 67b, 65c, and 67c communicating with the headers 69a, 69bu, 69bd, 69cu, and 69cd and forming the passage groups 66a, 64b, 66b, 64c, and 66c on the upstream side Dcu with respect to the headers 69a, 69bu, 69bd, 69cu, and 69cd, respectively, is smaller than the number of the plurality of cooling passages 62a, 62b, 65b, 62c, and 65c communicating with the headers 69a, 69bu, 69bd, 69cu, and 69cd and forming the passage groups 61a, 61b, 64b, 61c, and 64c on the downstream side Dcd with respect to the headers 69a, 69bu, 69bd, 69cu, and 69cd, respectively.

In this aspect, the number of the plurality of cooling passages 67a, 65b, 67b, 65c, and 67c forming the passage groups 66a, 64b, 66b, 64c, and 66c on the upstream side Dcu, respectively, is smaller than the number of the plurality of cooling passages 62a, 62b, 65b, 62c, and 65c forming the passage groups 61a, 61b, 64b, 61c, and 64c on the downstream side Dcd, respectively. For this reason, a flow speed of the cooling air Ai flowing through the plurality of cooling passages 67a, 65b, 67b, 65c, and 67c forming the passage groups 66a, 64b, 66b, 64c, and 66c on the upstream side Dcu, respectively, is faster than a flow speed of the cooling air Ai flowing through the plurality of cooling passages 62a, 62b, 65b, 62c, and 65c forming the passage groups 61a, 61b, 64b, 61c, and 64c on the downstream side Dcd, respectively. Therefore, heat transfer coefficients between the cooling air Ai flowing through the plurality of cooling passages 67a, 65b, 67b, 65c, and 67c forming the passage groups 66a, 64b, 66b, 64c, and 66c, on the upstream side Dcu, respectively, and portions of the transition piece 50 at which the passage groups 66a, 64b, 66b, 64c, and 66c on the upstream side Dcu are formed are substantially the same as or higher than heat transfer coefficients between the cooling air Ai flowing through the plurality of cooling passages 62a, 62b, 65b, 62c, and 65c forming the passage groups 61a, 61b, 64b, 61c, and 64c on the downstream side Dcd and portions of the transition piece 50 at which the passage groups 61a, 61b, 64b, 61c, and 64c on the downstream side Dcd are formed.

(5) According to the transition piece 50 of a fifth aspect, in the transition piece 50 of any one of the first to fourth aspects, a cross-sectional area of each of portions 67au on the upstream side Dcu of the plurality of final cooling passages 67a included in the bending inner-side plate portion 60a is smaller than a cross-sectional area of any of portions 67ad on the downstream side Dcd of the plurality of final cooling passages 67a included in the bending inner-side plate portion 60a.

The cross-sectional area of the portion 67au on the upstream side Dcu of each of the final cooling passages 67a of the bending inner-side plate portion 60a is smaller than the cross-sectional area of the portion 67ad on the downstream side Dcd of each of the final cooling passages 67a. For this reason, a flow speed of the cooling air Ai flowing through the portion 67au on the upstream side Dcu of the final cooling passage 67a is faster than a flow speed of the cooling air Ai flowing through the portion 67ad on the downstream side Dcd of the final cooling passage 67a. Therefore, a heat transfer coefficient between the cooling air Ai flowing through the portion 67au on the upstream side Dcu of the final cooling passage 67a and a periphery of the portion 67au on the upstream side Dcu of the final cooling passage 67a in the transition piece 50 is substantially the same as or higher than a heat transfer coefficient between the cooling air Ai flowing through the portion 67ad on the downstream side Dcd of the final cooling passage 67a and a periphery of the portion 67ad on the downstream side Dcd of the final cooling passage 67a in the transition piece 50.

(6) According to the transition piece 50 of a sixth aspect, in the transition piece 50 of any one of the first to fifth aspects, the number of the at least one header 69a of the bending inner-side plate portion 60a is 1, and the number of the at least one headers 69bu and 69bd of the bending outer-side plate portion 60b and of the at least one headers 69cu and 69cd of each of the pair of side plate portions 60c is 2 or more.

For example, the combustor in the above embodiment is understood as follows.

According to a seventh aspect, there is provided a combustor 40 including: the transition piece 50 according to any one of the first to sixth aspects; and a burner 42 that sprays fuel F and compressed air A into the combustion gas flow path 49.

For example, a gas turbine in the above embodiment is understood as follows.

According to an eighth aspect, there is provided a gas turbine 10 including: the combustor 40 according to the seventh aspect; a compressor 20 that compresses air to send the compressed air A to the combustor 40; a turbine 30 to be driven by the combustion gas G generated in the combustor 40; and an intermediate casing 13. The compressor 20 includes a compressor rotor 21 that is rotatable around a rotor axis Ar, and a compressor casing 24 covering an outer periphery of the compressor rotor 21. The turbine 30 includes a turbine rotor 31 that is rotatable around the rotor axis Ar, and a turbine casing 34 covering an outer periphery of the turbine rotor 31. The compressor rotor 21 and the turbine rotor 31 are connected to each other to form a gas turbine rotor 11. The compressor casing 24 and the turbine casing 34 are connected to each other through the intermediate casing 13. The transition piece 50 of the combustor 40 is disposed inside the intermediate casing 13 such that the bending outer-side plate portion 60b faces the gas turbine rotor 11 and the bending inner-side plate portion 60a faces the intermediate casing 13.

For example, gas turbine equipment in the above embodiment is understood as follows.

According to a ninth aspect, there is provided gas turbine equipment including: the gas turbine 10 according to the eighth aspect; a cooler 15 that cools some of the air compressed by the compressor 20; and a boost compressor 16 that pressurizes the air cooled by the cooler 15, and that sends the pressurized air to the first cooling passages 62a included in the bending inner-side plate portion 60a, to the first cooling passages 62b included in the bending outer-side plate portion 60b, and to the first cooling passages 62c included in each of the pair of side plate portions 60c, as the cooling medium.

### INDUSTRIAL APPLICABILITY

According to one aspect of the present disclosure, the manufacturing cost of the transition piece can be suppressed while ensuring durability of the transition piece.

### REFERENCE SIGNS LIST

10: Gas turbine
11: Gas turbine rotor
13: Intermediate casing
14: Gas turbine casing
15: Cooler
16: Boost compressor
17: Regulation valve
18: Air bleed line
19: Cooling air line
20: Compressor
21: Compressor rotor
22: Rotor shaft
23: Rotor blade row
24: Compressor casing
25: Stator vane row
30: Turbine
31: Turbine rotor
32: Rotor shaft
33: Rotor blade row
34: Turbine casing
35: Stator vane row
40: Combustor
41: Main body
42: Burner
43: Frame
44: Cooling air jacket
45: Acoustic damper
46: Space defining portion
47: Acoustic hole
48: Acoustic cover
49: Combustion gas flow path
50: Transition piece
51: Joint plate
52: Outer plate
52o: Outer peripheral surface
52c: Joint surface
53: Long groove
54: Inner plate
54i: Inner peripheral surface
54c: Joint surface
55: Passage
60a: Bending inner-side plate portion
61a: First passage group (of bending inner-side plate portion)
62a: First cooling passage (of bending inner-side plate portion)
63a: Inlet (of bending inner-side plate portion)
66a: Final passage group (of bending inner-side plate portion)
67a: Final cooling passage (of bending inner-side plate portion)
68a: Outlet (of bending inner-side plate portion)
67ad: Portion on downstream side (of final cooling passage)
67au: Portion on upstream side (of final cooling passage)
69a: Header (of bending inner-side plate portion)
60b: Bending outer-side plate portion
61b: First passage group (of bending outer-side plate portion)
62b: First cooling passage (of bending outer-side plate portion)
63b: Inlet (of bending outer-side plate portion)
64b : Second passage group (of bending outer-side plate portion)
65b: Second cooling passage (of bending outer-side plate portion)
66b: Final passage group (of bending outer-side plate portion)
67b: Final cooling passage (of bending outer-side plate portion)
68b: Outlet (of bending outer-side plate portion)
69bd: Downstream header (of bending outer-side plate portion)
69bu: Upstream header (of bending outer-side plate portion)
60c: Side plate portion
61c: First passage group (of side plate portion)
62c: First cooling passage (of side plate portion)
63c: Inlet (of side plate portion)
64c: Second passage group (of side plate portion)
65c: Second cooling passage (of side plate portion)
66c: Final passage group (of side plate portion)
67c: Final cooling passage (of side plate portion)
68c: Outlet (of side plate portion)
69cd: Downstream header (of side plate portion)
69cu: Upstream header (of side plate portion)
Ao: Outside air
A: Compressed air
Ai: Cooling air (cooling medium)
F: Fuel
G: Combustion gas
Ar: Rotor axis
Da: Rotor axis direction
Dau: Rotor axis upstream side
Dad: Rotor axis downstream side
Pv: Imaginary plane
Ac: Combustor axis (or simply axis)
Dca: Combustor axis direction (or simply axis direction)
Dcu: Upstream side
Dcd: Downstream side
Dcc: Circumferential direction
Dci: Bending inner side
Dco: Bending outer side

1. A transition piece that is formed along an axis bent within an imaginary plane, in a tubular shape around the axis and that defines a periphery of a combustion gas flow path through which combustion gas flows from an upstream side to a downstream side in an axis direction in which the axis extends, the piece comprising:
a pair of side plate portions facing the imaginary plane and facing each other with the axis interposed between the pair of side plate portions;
a bending inner-side plate portion that is disposed on a bending inner side on which a portion on the downstream side of the axis is bent with respect to a portion on the upstream side of the axis, with respect to the axis, and that is connected to ends on the bending inner side of the pair of side plate portions; and
a bending outer-side plate portion that is disposed on a bending outer side opposite the bending inner side with respect to the axis, that faces the bending inner-side plate portion with the axis interposed between the bending outer-side plate portion and the bending inner-side plate portion, and that is connected to ends on the bending outer side of the pair of side plate portions,
wherein each of the bending inner-side plate portion, the bending outer-side plate portion, and the pair of side plate portions includes a plurality of passage groups each including a plurality of cooling passages which extend in the axis direction, which are arranged in a circumferential direction with respect to the axis, and through which a cooling medium flows, and at least one header which extends in the circumferential direction and through which the cooling medium flows,
the plurality of passage groups of each of the bending inner-side plate portion, the bending outer-side plate portion, and the pair of side plate portions are arranged in the axis direction, and the header is disposed between the plurality of passage groups in the axis direction,
the plurality of passage groups of each of the bending inner-side plate portion, the bending outer-side plate portion, and the pair of side plate portions communicate with each other through the header disposed between the plurality of passage groups,
medium inlets into which the cooling medium flows are formed at respective ends on the downstream side of a plurality of first cooling passages that are the plurality of cooling passages forming a first passage group located furthest to the downstream side, among the plurality of passage groups of each of the bending inner-side plate portion, the bending outer-side plate portion, and the pair of side plate portions,
medium outlets from which the cooling medium flows out are formed at respective ends on the upstream side of a plurality of final cooling passages that are the plurality of cooling passages forming a final passage group located furthest to the upstream side, among the plurality of passage groups of each of the bending inner-side plate portion, the bending outer-side plate portion, and the pair of side plate portions, and
the number of the at least one headers of the bending inner-side plate portion is smaller than the number of the at least one headers of each of the bending outer-side plate portion and the pair of side plate portions.

2. The transition piece according to claim 1,
wherein in each of the bending inner-side plate portion, the bending outer-side plate portion, and the pair of side plate portions, a passage density that is a total cross-sectional area of the plurality of cooling passages per unit circumferential length in the plurality of cooling passages communicating with the header and forming the passage group on the upstream side with respect to the header is less than a passage density of the plurality of cooling passages communicating with the header and forming the passage group on the downstream side with respect to the header.

3. The transition piece according to claim 2,
wherein in each of the bending inner-side plate portion, the bending outer-side plate portion, and the pair of side plate portions, the passage density of the final passage group is 25% to 45% of the passage density of the passage group located on the downstream side of the header with which the final passage group communicates.

4. The transition piece according to 3 claim 1,
wherein in each of the bending inner-side plate portion, the bending outer-side plate portion, and the pair of side plate portions, the number of the plurality of cooling passages communicating with the header and forming the passage group on the upstream side with respect to the header is smaller than the number of the plurality of cooling passages communicating with the header and forming the passage group on the downstream side with respect to the header.

5. The transition piece according to 4 claim 1,
wherein a cross-sectional area of each of portions on the upstream side of the plurality of final cooling passages included in the bending inner-side plate portion is smaller than a cross-sectional area of any of portions on the downstream side of the plurality of final cooling passages included in the bending inner-side plate portion.

6. The transition piece according to claim 1,
wherein the number of the at least one headers of the bending inner-side plate portion is 1, and
the number of the at least one headers of each of the bending outer-side plate portion and the pair of side plate portions is 2 or more.

7. A combustor comprising:
the transition piece according to claim 1; and
a burner that sprays fuel and compressed air into the combustion gas flow path.

8. A gas turbine comprising:
the combustor according to claim 7;
a compressor that compresses air to send the compressed air to the combustor;
a turbine to be driven by the combustion gas generated in the combustor; and
an intermediate casing,
wherein the compressor includes a compressor rotor that is rotatable around a rotor axis, and a compressor casing covering an outer periphery of the compressor rotor,
the turbine includes a turbine rotor that is rotatable around the rotor axis, and a turbine casing covering an outer periphery of the turbine rotor,
the compressor rotor and the turbine rotor are connected to each other to form a gas turbine rotor,
the compressor casing and the turbine casing are connected to each other through the intermediate casing, and
the transition piece of the combustor is disposed inside the intermediate casing such that the bending outer-side plate portion faces the gas turbine rotor and the bending inner-side plate portion faces the intermediate casing.

9. Gas turbine equipment comprising:
the gas turbine according to claim 8;
a cooler that cools some of the air compressed by the compressor; and
a boost compressor that pressurizes the air cooled by the cooler, and that sends the pressurized air to the first cooling passages included in each of the bending inner-side plate portion, the bending outer-side plate portion, and the pair of side plate portions, as the cooling medium.
